(19) United States
(12) Patent Application Publication
(10) Pub. No.: US 2008/0014973 A1
(43) Pub. Date: Jan. 17, 2008

(54) Apparatus and method for sending and receiving a message in bluetooth mobile device

(75) Inventor: Min-Won Cho, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/715,993

(22) Filed: Mar. 9, 2007

(30) Foreign Application Priority Data
Mar. 9, 2006 (KR) 2006-0022152

(51) Int. Cl. H04Q 7/20; H04M 1/00

(52) U.S. Cl. 455/466; 455/550.1

(57) ABSTRACT

An apparatus and method for sending/receiving a message in a Bluetooth mobile device is provided. A message receiving method in a Bluetooth mobile device according to present invention includes setting up a Bluetooth-connection with a mobile communication terminal; determining whether a message is received from the mobile communication terminal; and displaying contents of the received message on a display unit when the message is received. Accordingly, a received message can be confirmed or a new message can be written and sent through a Bluetooth mobile device, without a user manipulating the mobile communication terminal, such that user convenience is increased.

### PRIORITY

This application claims priority under 35 U.S.C. § 119 to an application filed in the Korean Intellectual Property Office on Mar. 9, 2006 and assigned Serial No. 2006-22152, the contents of which are incorporated herein by reference.

### BACKGROUND OF THE INVENTION

1. Field of the Invention

The present invention relates generally to an apparatus and method for sending/receiving a message in a Bluetooth mobile device, and in particular, to an apparatus and method for allowing a message that is received by a mobile communication terminal to be simultaneously confirmed in a Bluetooth mobile device, and for writing and sending a message in a Bluetooth mobile device, to a mobile communication terminal.

2. Description of the Related Art

With the development of electronic and communication products, mobile communication terminals are being widely used. Hence, in order to satisfy user demand, these mobile communication terminals are being developed to have multi-functional features.

In addition to a voice communication function, mobile communication terminals now include a variety of additional software functions, such as for receiving and playing music files and Video On Demand (VOD), as well as for photographing objects and storing captured images in an album.

As for hardware, a variety of peripheral devices that attach to the mobile terminals have been developed. Examples of such peripheral devices include detachable or built-in digital cameras, Digital Multimedia Broadcasting (DMB) receivers capable of receiving over-the-air broadcasting, and Bluetooth headset devices enabling hands-free communication through Bluetooth communication terminals.

Since Bluetooth devices wirelessly connect digital devices, achieving a small size, economical costs, and low power consumption, the Bluetooth devices are now widely used in a variety of fields. Although the Bluetooth devices are mainly used for hands-free communication, manufacturers of mobile communication terminals are adding a variety of additional functions (e.g., MP3 player function) besides the hands-free communication in order to attract more users.

Typically, the Bluetooth devices can communicate with a mobile communication terminal separately from the mobile communication terminal itself at a predetermined distance (10 m˜100 m). If however, individual functions of the mobile communication terminal were used through the Bluetooth devices, without directly manipulating the mobile communication terminal, user convenience would be greatly increased. For example, when a message received by the mobile communication terminal can be received through the bluetooth devices simultaneously, a user can confirm the received message, without manipulating the mobile communication terminal located in a remote site.

### SUMMARY OF THE INVENTION

An object of the present invention is to substantially solve at least the above problems and/or disadvantages and to provide at least the advantages below. Accordingly, an object of the present invention is to provide an apparatus and method for allowing a message received by a mobile communication terminal to be simultaneously confirmed in a Bluetooth mobile device.

Another object of the present invention is to provide an apparatus and method for writing a message in a Bluetooth mobile device and sending the message to a mobile communication terminal.

According to one aspect of the present invention, there is provided a method of receiving a message in a Bluetooth mobile device. The method includes setting up a Bluetooth-connection with a mobile communication terminal; determining whether a message is received from the mobile communication terminal; and displaying contents of the received message on a display unit when the message is received.

According to another aspect of the present invention, there is provided a method of sending a message in a Bluetooth mobile device. The method includes displaying a virtual keypad on a display unit when a message input request key is pressed; inputting keys of the displayed keypad; writing a message corresponding to the input keys; and sending the written message to the mobile communication terminal and requesting sending the message, when a send key is pressed.

### BRIEF DESCRIPTION OF THE DRAWINGS

The above and other objects, features, and advantages of the present invention will become more apparent from the following detailed description when taken in conjunction with the accompanying drawings in which:

FIG. 1 is a perspective view of a mobile communication terminal and a Bluetooth mobile device performing near field communication according to the present invention;

FIG. 2 is a schematic diagram of a Bluetooth mobile device according to the present invention;

FIG. 3 is a flow diagram illustrating a process for receiving a message from a mobile communication terminal and processing the message in a Bluetooth mobile device according to the present invention;

FIG. 4 is a flow diagram illustrating a process for confirming a received message in a Bluetooth mobile device according to the present invention;

FIG. 5 is a flow diagram illustrating a process for sending a message in a Bluetooth mobile device according to the present invention; and

FIGS. 6 to 8 are views of a screen of a mobile device according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail. Also, the terms used herein are defined according to the functions of the present invention. Thus, the terms may vary depending on user's or operator's intension and usage. That is, the terms used herein must be understood based on the descriptions made herein.

An example of the Bluetooth mobile device interworking with the mobile communication terminal is a Bluetooth headset. A mobile device having both an MP3 (MPEG audio layer-3) player function and Bluetooth (hereinafter, Bluetooth MP3 player) will be described as an example.

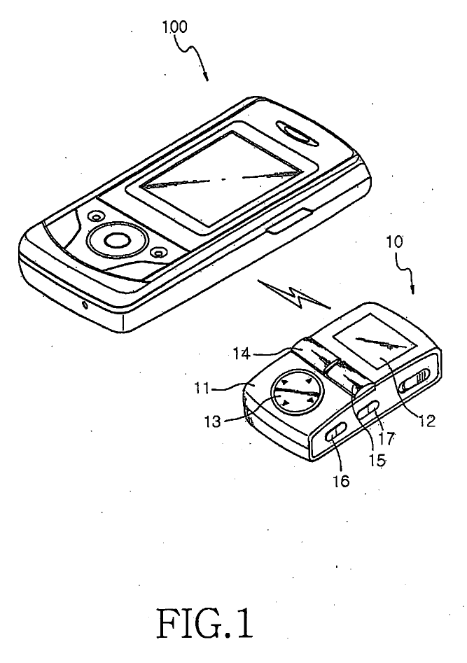

FIG. 1 is a perspective view of a mobile communication terminal 100 and a Bluetooth mobile device 10 performing near field communication according to the present invention. Although the Bluetooth MP3 player will be illustrated as an example, other mobile devices capable of Bluetooth communication may be used as the Bluetooth mobile device according to the prevent invention.

Referring to FIG. 1, the Bluetooth MP3 player 10 includes a display unit 12 with a predetermined area, which is installed on a body 11 having a predetermined shape and size. A plurality of keys 13, 14, 15, 16, and 17 are installed on predetermined positions of the body 11 to perform their functions. Examples of the keys installed under the display unit 12 may be a key 14 that serves as a call/cancel (delete) key, a key 15 that serves as a menu/confirm key, and navigation keys 13 for menu search/music search/volume control. Examples of the keys installed on a side surface of the display unit 12 may be a power on/off key 16, and a Bluetooth on/off key 17. Although not shown, a variety of keys, such as a hold key, may be additionally installed.

Also, an ear jack terminal (not shown) may be installed in an appropriate position of the body 11 of the Bluetooth MP3 player 10 to electrically connect a predetermined earphone device thereto. Furthermore, a microphone device installed in an appropriate position of the body 11 of the Bluetooth MP3 player 10 may be used as a voice communication unit when a user makes an outgoing call through near field communication with the mobile communication terminal 100.

The Bluetooth MP3 player 10 performs the near field communication with the mobile communication terminal 100 besides a basic MP3 player function. In operation the Bluetooth MP3 player 10 receives a message (e.g., Short Message Service (SMS) message and Multimedia Messaging Service (MMS) message), which is received by a mobile communication terminal 100, through Bluetooth communication. The Bluetooth MP3 player 100 displays the received message on the display unit 12, so that a user can directly confirm the message received in the mobile communication terminal 100. Also, a virtual keypad is displayed on the display unit 12 of the Bluetooth MP3 player 10, so that a message can also be written in the Bluetooth mobile device via limited number of keys. Here, the user may use the navigation keys 13 in order to select virtual keys displayed on the display unit 12. However, the present invention should not be construed as being limited to the use of the navigation keys 13. For example, the display unit 12 is configured as a touch screen, so that a corresponding key can be selected by a user touching the touch screen.

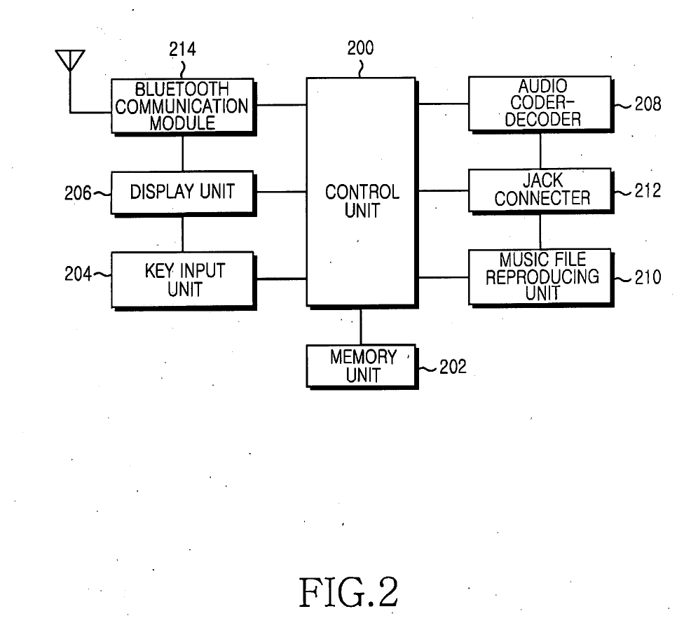

FIG. 2 is a block diagram of a Bluetooth mobile device 10 according to the present invention.

In FIG. 2, the Bluetooth mobile device 10 includes a control unit (e.g., a microprocessor unit (MPU)) 200, a memory unit 202, a key input unit 204, a display unit 206, an audio coder-decoder (CODEC) 208, a music file reproducing unit 210, a jack connecter 212, and a Bluetooth communication module 214.

The control unit 200 controls the overall operation of the Bluetooth mobile device 10. For example, the control unit 200 performs processing and controlling for Bluetooth communication with the mobile communication terminal 100, and controls the overall operation related to play in music files. Moreover, the control unit 200 receives and sends messages using Bluetooth communication with the mobile communication terminal 100.

The memory unit 202 includes a flash memory, a random access memory (RAM), and a read only memory (ROM). The memory unit 202 stores program data for controlling the overall operation of the Bluetooth mobile device 10, temporary data generated during an operation of the Bluetooth mobile device 10,system parameters, and music files. The memory unit 202 also stores recent messages received from the mobile communication terminal 100 in a predetermined storing region (e.g., an incoming message box).

As illustrated in FIG. 1, the key input unit 204 includes a plurality of keys enabling manipulation of the Bluetooth mobile device, and provides key input data that corresponds to a key pressed by the user to the control unit 200. The display unit 206 displays status information generated during the operation of the Bluetooth mobile device 10, numerals and characters, moving and still pictures, and so on. The display unit 206 may be a liquid crystal display (LCD) and may be implemented as a touch screen in order to the number of keys.

The audio CODEC 208 processes a voice signal exchanged with the mobile communication terminal 100. The music file reproducing unit 210 decompresses a music file (e.g., MP3 file) received from the memory unit 202, and reproduces the music file into an analog audio signal. The jack connecter 212 connects an audio signal reproduced by the audio CODEC 208 or an audio signal reproduced by the music file reproducing unit 210 to an ear microphone device installed in the Bluetooth mobile device 10.

The Bluetooth communication module 214 generates a packet of a predetermined specification by adding a predetermined header in a host control interface (HIC) message received from the control unit 200. Further, the Bluetooth communication module 214 converts the packet into a transmissible radio-frequency (RF) signal to transmit the RF signal through an antenna. Also, the Bluetooth communication module converts an RF signal received through the antenna into a baseband signal, extracts an HCI message from the baseband signals, and provides the extracted message to the control unit 200. The HCI message (or the packet) is classified into a command packet, an event packet, and a data packet. The command packet allows the Bluetooth communication module 214 to be used in various manners.

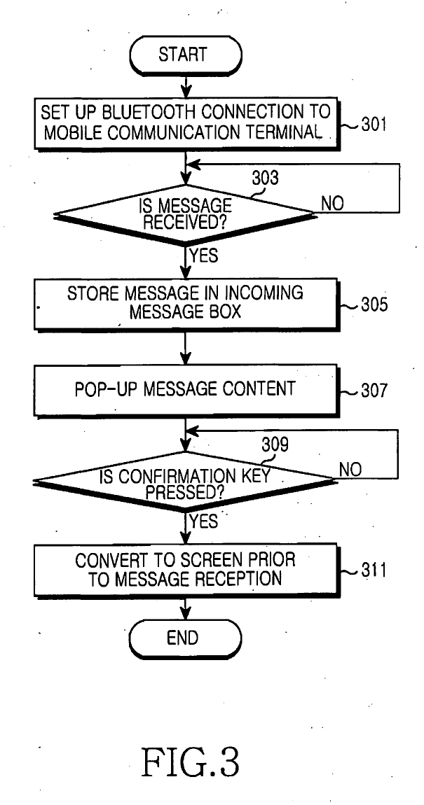

FIG. 3 is a flow diagram illustrating a process for receiving a message from a mobile communication terminal in a Bluetooth mobile device according to the present invention.

Referring to FIG. 3, in step 301, the control unit 200 performs a Bluetooth connection with the mobile communication terminal 100 by user manipulation. Where the Bluetooth connection with the mobile communication terminal 100 is made, the control unit 200 determines in step 303 whether a message (e.g., an SMS message and an MMS message) is received from the mobile communication terminal 100. Here, it is assumed that the mobile communication terminal 100 is set to automatically send a message received from a base station to the Bluetooth mobile device 10.

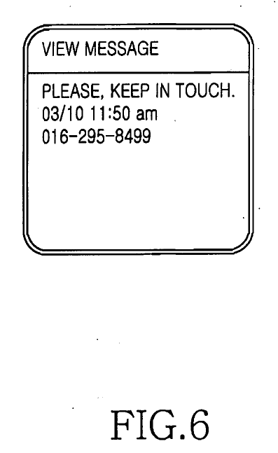

When the message is received from the mobile communication terminal 100, the control unit 200 stores the received message in a predetermined region (e.g., an incoming message box) of the memory unit 202 in step 305. In step 307, the control unit 200 displays contents of the received message on the display unit 206. For example, the message contents may be displayed as illustrated in FIG. 6. Here, the alarm operation (e.g., a buzz and a lamp) notifying message reception may be performed.

When another function (e.g., music reproducing) is performed in the Bluetooth mobile device 10, the message contents may pop up, without stopping the function that is being performed. Alternatively, the message contents may pop up after the function that is being performed is stopped. Also, to notify the message reception, the message contents may be directly displayed as illustrated in an embodiment of the present invention or only a reception alarming service may be performed according to demands of mobile network operators.

Where the message contents are displayed, the control unit 200 determines in step 309 whether a confirmation key is pressed by the user. When the confirmation key is pressed, the control unit 200 converts message reception screen to a previous screen thereof in step 311. Thereafter, the control unit 200 terminates the process.

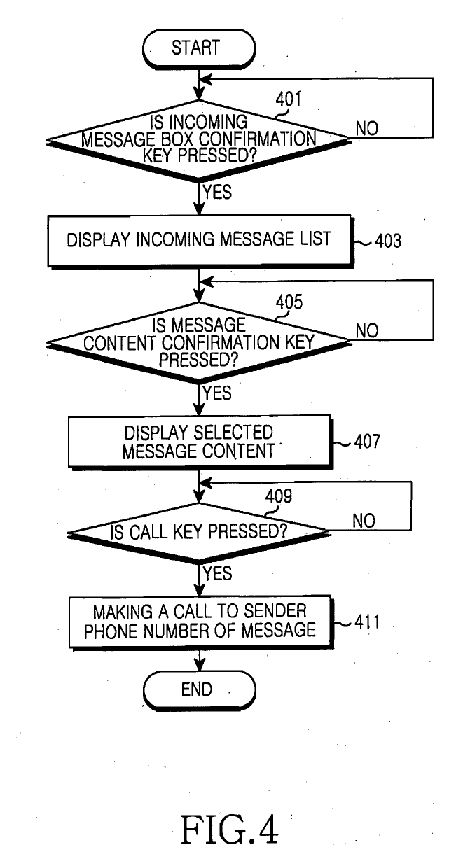

FIG. 4 is a flow diagram illustrating a process for confirming a received message in a Bluetooth mobile device according to the present invention.

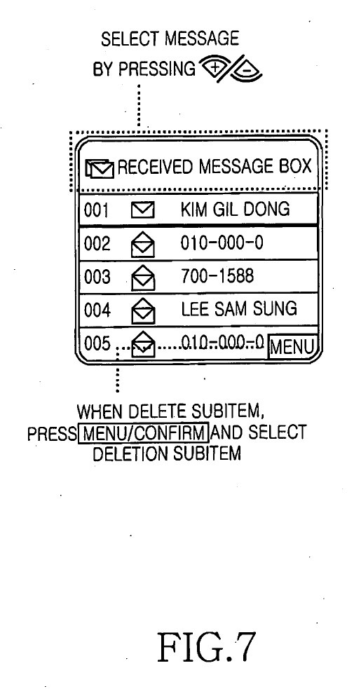

Referring to FIG. 4, in step 401, the control unit 200 determines whether an incoming message box confirmation key is pressed by the user. When the incoming message box confirmation key is pressed, the control unit 200 displays an incoming message list stored in the incoming message box on the display unit 206 in step 403. For example, the incoming message list may be displayed as illustrated below in FIG. 7. Here, the user selects a target message using navigation keys 13.

After displaying the incoming message list, the control unit 200 then determines whether a message content confirmation key is pressed in step 405. When the message content confirmation key is pressed, the control unit 200 displays contents of a current selected message on the display unit 206 in step 407. Here the user may press a call key to make an outgoing call to a phone number of a sender of the corresponding message (hereinafter, sender number).

In step 409, the control unit 200 determines whether the call key is pressed by the user. When the call key is pressed, the control unit 200 sends the sender number of the displayed message to the mobile communication terminal 100 to request making a call in step 411. For example, the control unit 200 generates an HCI message requesting making a call, and sends the HCI message to the Bluetooth communication module 214. Then, the Bluetooth communication module 214 converts the HCI message into a transmissible message format according to a predetermined specification, and sends the converted message to the mobile communication terminal 100. The mobile communication terminal 100 receiving the phone number data from the Bluetooth mobile device 10 makes an outgoing call to the sender number.

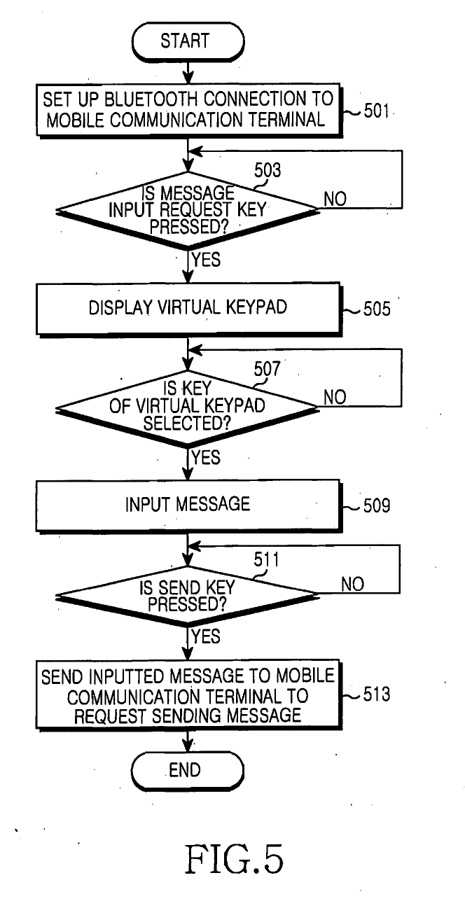

FIG. 5 is a flow diagram illustrating a process for sending a message in a Bluetooth mobile device according to the present invention.

In FIG. 5, the control unit 200 performs a Bluetooth connection with the mobile communication terminal 100 in step 501. When the Bluetooth connection with the mobile communication terminal 100 is made, the control unit 200 determines in step 503 whether a message input request key is pressed by user.

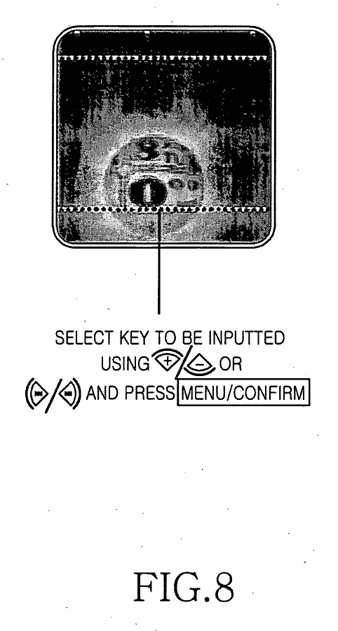

When the message input request key is pressed, the control unit 200 then displays a virtual keypad allowing character input on the display unit 206. The virtual keypad may be identical toad key matrix of a normal mobile communication terminal. For example, the virtual keypad may be displayed in a 4×3 key matrix configuration as illustrated below in FIG. 8, and a user may manipulate the navigation keys to move a selection indicator (or an enlargement indicator) to a target key. Thereafter, the user presses a confirmation key to select the corresponding key.

Accordingly, after the virtual keypad is displayed, the control unit 200 detects in step 507 whether a key of the virtual keypad is selected by the user. When the key selection is detected, the control unit 200 inputs a character corresponding to the selected key to write a message in step 507. In step 507, inputting a sender's phone number and a recipient's phone number is performed, besides the writing of a message.

After the message input is completed, the control unit 200 determines in step 511 whether a send key is pressed. When the send key is pressed, the control unit 200 sends the inputted message to the mobile communication terminal 100 to request message transmission in step 513. The mobile communication terminal 100 receiving the message from the Bluetooth mobile device 10 transmits the received message to a base station.

Although not shown in FIG. 5, when the display unit 206 of the Bluetooth mobile device 10 is operated as a touch screen, the users may input characters (including numerals) by touching keys displayed on the display unit 206 using their fingers or a stylus pen.

As described above, in the present invention, a message may be received and confirmed or a new message may be written and sent through the Bluetooth mobile device 10, without direct manipulation of the mobile communication terminal 100 and, thus it is possible to increase user's convenience. Particularly, since the message received by the mobile communication terminal 100 is automatically sent to the Bluetooth mobile device 10, the user can directly confirm the received message, without manipulating the mobile communication terminal 100 located in a remote site.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method of receiving a message in a Bluetooth mobile device, comprising the steps of:
setting up a Bluetooth-connection with a mobile communication terminal;
determining whether a message is received from the mobile communication terminal; and
displaying contents of the received message on a display unit when the message is received.

2. The method of claim 1, further comprising:
determining whether a confirmation key is pressed in a state where the contents of the message is displayed; and
converting a message reception screen to a previous screen thereof when the confirmation key is pressed.

3. The method of claim 1, further comprising storing the received message to an incoming message box of a memory unit.

4. The method of claim 3, further comprising the steps of:
displaying an incoming message list stored in the incoming message box when a message confirmation key is pressed; and
displaying contents of a selected message from the incoming message list when the confirmation key is pressed.

5. The method of claim 4, further comprising transmitting a phone number of a sender of the message to the mobile communication terminal to request making a call, when a call key is pressed in a state where the message contents are displayed.

6. A method of sending a message in a Bluetooth mobile device, comprising the steps of:
displaying a virtual keypad on a display unit when a message input request key is pressed;
inputting keys of the displayed keypad;
writing a message using the input keys; and
sending the written message to the mobile communication terminal and requesting sending the message, when a send key is pressed.

7. The method of claim 6, wherein the virtual keypad has a 4×3 key matrix configuration.

8. The method of claim 6, wherein the step of inputting the keys comprises:
manipulating a navigation key to move a selection indicator to any one key; and
processing input of a key where the selection indicator is located, when a confirmation key is pressed.

9. The method of claim 6, wherein the step of inputting the keys comprises:
detecting a screen touch; and
processing input of a key displayed on the touched position.

10. An apparatus for receiving a message in a Bluetooth mobile device, comprising:
a Bluetooth communication module for performing Bluetooth communication with a mobile communication terminal;
a control unit receiving a message from the mobile communication terminal through the Bluetooth communication module; and
a display unit displaying contents of the received message under control of the control unit and displaying a previous screen of a message reception screen when a confirmation key is pressed.

11. The apparatus of claim 10, further comprising a memory unit for storing the received message in an incoming message box.

12. An apparatus for sending a message in a Bluetooth mobile device, comprising:
a Bluetooth communication module for performing Bluetooth communication with a mobile communication terminal;
a display unit for displaying a virtual keypad when a message input request key is pressed; and
a control unit writing a message corresponding to selected keys of the keypad when the keys of the keypad are selected, and sending the written message to the mobile communication terminal through the Bluetooth communication module to request sending the message.

13. The apparatus of claim 12, wherein the keys of the keypad are selected by manipulation of navigation keys.

14. The apparatus of claim 12, wherein the keys of the keypad are selected by a screen touch.

15. A Bluetooth mobile device comprising:
means for setting up a Bluetooth-connection with a mobile communication terminal;
means for determining whether a message is received from the mobile communication terminal; and
means for displaying contents of the received message on a display unit when the message is received.

16. The device of claim 15, further comprising:
means for determining whether a confirmation key is pressed in a state where the contents of the message is displayed; and
means for converting a message reception screen to a previous screen thereof when the confirmation key is pressed.

17. A Bluetooth mobile device comprising:
means for displaying a virtual keypad on a display unit when a message input request key is pressed;
means for inputting keys of the displayed keypad;
means for writing a message corresponding to the input keys; and
means for sending the written message to the mobile communication terminal and requesting sending the message, when a send key is pressed.

18. A computer-readable recording medium having recorded thereon a program for receiving a message in a Bluetooth mobile device, comprising:
a first code segment, for setting up a Bluetooth-connection with a mobile communication terminal;
a second code segment, for determining whether a message is received from the mobile communication terminal; and
a fourth code segment, for displaying contents of the received message on a display unit when the message is received.

19. A computer-readable recording medium having recorded thereon a program for sending a message in a Bluetooth mobile device, comprising:
a first code segment, displaying a virtual keypad;
a second code segment, inputting keys of the displayed keypad;
a third code segment, writing a message using the input keys; and
a fourth code segment, sending the written message to the mobile communication terminal.
